(19) United States
(12) Patent Application Publication
(10) Pub. No.: US 2025/0361036 A1
(43) Pub. Date: Nov. 27, 2025

(54) MULTILAYER MICRO-FOAM SHIELD WITH EMBEDDED PHASE-CHANGE MATERIALS FOR MITIGATING UNTRACEABLE DEBRIS

(71) Applicants: The Regents of the University of Colorado, a body corporate, Denver, CO (US); AD Engineering, LLC, Dayton, OH (US); Wright State University, Dayton, OH (US)

(72) Inventors: Hui WAN, Colorado Springs, CO (US); Armando DELEON, Dayton, OH (US); Anthony N. PALAZOTTO, Dayton, OH (US)

(21) Appl. No.: 19/214,294

(22) Filed: May 21, 2025

Related U.S. Application Data
(60) Provisional application No. 63/650,831, filed on May 22, 2024.

(51) Int. Cl. B64G 1/56; B32B 5/18; B32B 15/04; B32B 15/20

(52) U.S. Cl. CPC B64G 1/56; B32B 5/18; B32B 15/046; B32B 15/20; B32B 2266/104; B32B 2605/18

(57) ABSTRACT

A debris shield may include one or more microfoam units, the one or more microfoam units comprising internal voids. The debris shield may include one or more phase change materials positioned within the internal voids. The debris shield may include an advanced composite material layer positioned over a surface of the one or more microfoam units.

### CROSS-REFERENCE TO RELATED APPLICATIONS

This application claims priority to and the benefit of U.S. Patent Application No. 63/650,831, filed May 22, 2024, and entitled An Orbit Cleaner for Untraceable Debris, the entire content of which is incorporated herein by reference.

### BACKGROUND

The challenges related to space debris are multifaceted and complex. One of the primary issues is the sheer volume and variety of debris. Currently, there are approximately 28,000 objects larger than 10 centimeters that are tracked and cataloged, but there are far more smaller objects—around 500,000 pieces between 1 and 10 centimeters, and over 100 million pieces smaller than 1 centimeter. These smaller fragments, though less likely to be tracked, can still cause substantial damage to spacecraft due to their high velocities.

Space debris poses a significant risk of collision with operational satellites and spacecraft. Even tiny debris fragments, moving at high speeds, can penetrate and severely damage or destroy critical components of satellites and space stations. The high relative velocities in orbit amplify the destructive potential of even the smallest particles. This situation contributes to the Kessler Syndrome, a scenario where the density of objects in low Earth orbit (LEO) is high enough that collisions between objects could cause a cascade effect. Each collision generates more debris, increasing the likelihood of further collisions. This self-sustaining cycle could render certain orbits unusable and significantly hinder space operations and future missions.

Tracking smaller debris is particularly challenging. While larger objects (greater than 10 centimeters) are regularly monitored, tracking smaller debris requires advanced technologies and constant updates. This tracking is crucial for collision avoidance but remains difficult due to the vast area of space and the high speeds of debris particles. Technological limitations also play a significant role in the problem. Current debris mitigation technologies, such as the Whipple shield and its variations, may protect against impacts but can create secondary debris clouds, increasing long-term risks. Additionally, most existing remediation technologies are tailored to specific debris types, making it hard to develop scalable solutions that can handle a wide range of debris sizes and materials.

The cost and feasibility of addressing space debris are also major concerns. Developing, deploying, and maintaining debris mitigation systems is expensive. The costs associated with collision avoidance maneuvers, protective shielding, and active debris removal missions add up, impacting the economics of space operations. Furthermore, the financial burden of potential damages from collisions influences satellite design, insurance premiums, and mission planning.

Ensuring the long-term sustainability of space activities necessitates effective debris management strategies. As the number of satellites and space missions increase, so does the potential for debris generation. Sustainable practices, such as designing satellites for end-of-life disposal and minimizing mission-related debris, are essential to prevent further exacerbation of the problem. Addressing these challenges requires innovative solutions, comprehensive monitoring, effective regulations, and global collaboration to ensure the continued safe and sustainable use of space.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

A microfoam shield comprises one or more microfoam stacked layers. The one or more microfoam stacked layers comprises internal voids. One or more phase change materials are positioned within the internal voids. An advanced composite material layer is positioned on top of the one or more microfoam stacked layers.

In one example embodiment, a debris shield includes one or more microfoam units, the one or more microfoam units including internal voids; one or more phase change materials positioned within the internal voids; and an advanced composite material layer positioned over a surface of the one or more microfoam units.

In one example embodiment, a debris shield includes a first microfoam unit including internal voids; a second microfoam unit including internal voids; and an advanced composite material layer positioned between the first and second microfoam units.

In one example embodiment, a microfoam shield includes an advanced composite material layer; a first microfoam unit positioned adjacent to the advanced composite material layer, the first microfoam unit including internal voids and a first porosity level; and a second microfoam unit positioned adjacent to the first microfoam unit, such that the first microfoam unit is positioned between the advanced composite material layer and the second microfoam unit, the second microfoam unit including internal voids and a second porosity level.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example embodiment of a debris shield.

FIG. 2 illustrates another example embodiment of a debris shield.

FIG. 3 illustrates another example embodiment of a debris shield.

FIG. 4 illustrates another example embodiment of a debris shield.

FIG. 5 illustrates another example embodiment of a debris shield.

FIG. 6 illustrates another example embodiment of a debris shield.

FIG. 7 illustrates another example embodiment of a debris shield.

### DETAILED DESCRIPTION

Disclosed embodiments include an advanced shield technology that integrates layers of open-cell microfoam and phase change materials (PCM). This novel shield design not only protects the spacecraft from debris impacts but also actively collects debris fragments generated during the impact process. This approach aims to prevent the release of additional debris into space, thereby mitigating long-term threats to spacecraft.

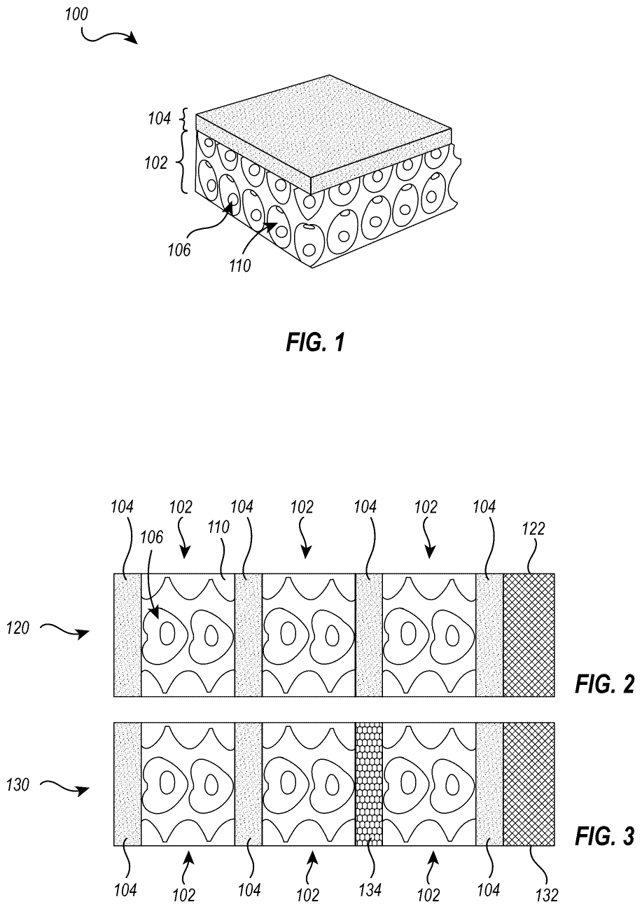

Disclosed embodiments utilizes layers of open-cell microfoam to protect spacecraft and satellites. As shown in FIG. 1, a debris shield 100 includes a microfoam unit 102 that may be covered by an advanced composite material layer 104. In some embodiments, the advanced composite material layer 104 may form an outer layer of the debris shield 100 and may be configured to have debris impinge thereon and pass therethrough to the microfoam unit 102. The microfoam unit 102 may be configured to break down and/or collect the debris therein.

The microfoam unit 102 may include an open cell configuration with one or more internal voids 106. In some embodiments, the microfoam unit 102 is formed of an aluminum foam. The porosity of the internal voids 106 may vary from one embodiment to another based on, for instance, the temperature and pressure during the manufacture process.

In some embodiments, the microfoam unit 102 may have a thickness of about 5.0 cm. In other embodiments, the microfoam unit 102 may have a thickness of about 1.0 cm, 2.0 cm, 2.5 cm, 3.0 cm, 3.5 cm, 4.0 cm, 4.5 cm, 5.5 cm, 6.0 cm, 6.5 cm, 7.0 cm, 7.5 cm, 8.0 cm, 9.0 cm, or any thickness between the foregoing values. In other embodiments, the microfoam unit 102 may have a thickness less than 1.0 cm or greater than 9.0 cm.

The internal voids 106 may be filled with PCM 110. The PCM 110 may be configured to collect fragments from the debris cloud during impact. Examples of the PCM 110 include, but are not limited to, paraffin wax, salt hydrates, eutectic salts, eutectic metals, microencapsulated PCMs, and composite PCMs.

The advanced composite material layer 104 may be formed of Nextel, Beta cloth, Kevlar, or similar materials, or combinations thereof. In some embodiments, the advanced composite material layer 104 may have a thickness of about 2.6 mm. In other embodiments, the advanced composite material layer 104 may have a thickness of about 0.5 mm, 1.0 mm, 1.5 mm, 2.0 mm, 2.5 mm, 3.0 mm, 3.5 mm, 4.0 mm, 4.5 mm, 5.0 mm, or any thickness between the foregoing values. In other embodiments, the advanced composite material layer 104 may have a thickness less than 0.5 mm or greater than 5.0 mm.

As noted above, the advanced composite layer 104 may form an exterior layer of the debris shield 100. The advanced composite layer 104 may be relatively soft and configured to slow or delay the impact of debris, causing the debris to break up primarily within the underlying microfoam unit 102.

When the debris penetrates through the advanced composite layer 104 and into the microfoam unit 102, the heat generated from the impact may melt the PCM 110, causing the PCM 110 to transition from a solid to a liquid. After the impact process ends, the PCM 110 may revert back to a solid phase, which causes the debris fragments to be collected and captured within the microfoam unit 102 instead of allowing them to spread uncontrollably over the impact region.

Disclosed embodiments allow for the adjustment of a debris shield's penetration depth and debris cloud distribution. This may be accomplished by, among other things, varying the thickness of the microfoam unit, the number and/or ordering of layers of the microfoam unit, the porosity of the microfoam unit layer(s), the diameter(s) of the ligaments of the microfoam unit, the materials of microfoam, the number of advanced composite material layers, and/or the addition of other layers.

For instance, FIG. 2 illustrates an embodiment of a debris shield 120 that includes stacks or layers of microfoam units 102 and advanced composite material layers 104. The particular number of stacks or layers may vary from one embodiment to another. The microfoam units 102 and the advanced composite material layers 104 may be substantially similar or identical to the microfoam unit 102 and advanced composite material layer 104 described above. For instance, the microfoam units 102 may include internal voids 106 that may be filled with PCM 110.

In some embodiments, at least some of the microfoam units 102 in the debris shield 120 may be substantially identical to one another. For instance, two or more of the microfoam units 102 may have the same or similar dimensions, porosities, and the like. In other embodiments, all of the microfoam units 102 may be identical to one another. In still other embodiments, all of the microfoam units 102 may be different from one another in at least some respect (e.g., dimension, porosity, etc.). Similarly, the advanced composite material layers 104 may be the same as one or more of the other advanced composite material layers 104 or different from one or more of the other advanced composite material layers 104. For instance, the materials used for and/or the dimensions of the advanced composite material layers 104 may be the same as or different from one another.

The microfoam units 102 and the advanced composite material layers 104 may be arranged such that a front side (the side towards the left of the figure) of each microfoam unit 102 engages and/or is covered by an advanced composite material layer 104. The back sides (the sides towards the right of the figure) of the microfoam units 102 may also engage and/or be covered by an advanced composite material layer 104. As shown in FIG. 2, some of the advanced composite material layers 104 may cover the front side of one microfoam unit 102 and the back side of another microfoam unit 102.

The debris shield 120 may also include a rear wall 122. The rear wall 122 may be formed of a substantially solid material. In some cases, the rear wall 122 may be formed of an aluminum alloy plate.

FIG. 3 illustrates another embodiment of a debris shield 130. The debris shield 130 may be similar or identical to the debris shield 120 in many respects, including stacks or layers of microfoam units 102, advanced composite material layers 104, and a back wall 132. In contrast to the debris shield 120, however, the illustrated debris shield 130 includes an aluminum alloy layer 134 in place of one of the advanced composite material layers 104. The layer 134 may enhance the strength of the debris shield 130. It should be appreciated that aluminum alloy is provided only as an example of the material for the layer 134 and that a number of different metals, ceramics, plastics, etc. can be used based upon desired characteristics.

While the layer 134 is illustrated behind two layers of microfoam units 102 and in front of one microfoam unit 102, this is only an example. As noted above, a debris shield may have any number of layers. The layer 134 may be positioned between various microfoam units 102 within the stack. Additionally, a debris shield may include multiple layers 134. Although not illustrated, the layer 134 may not replace an advanced composite material layer 104. Rather, for instance, the layer 134 may be placed in front of and/or behind the advanced composite material layer 104.

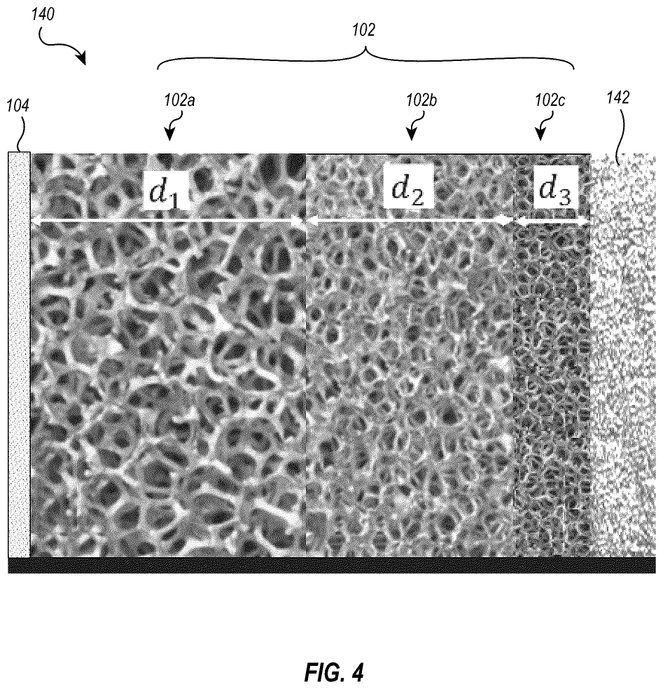

Attention is now directed to FIG. 4, which illustrates a debris shield 140 according to one example embodiment. The debris shield 140 includes an advanced composite material layer 104 that forms an outer surface thereof and a back wall 142. The advanced composite material layer 104 and the back wall 142 may be the same as or similar to the other advanced composite material layers and back walls, respectively, described herein. The debris shield 140 also includes a stack or multiple layers of microfoam units 102. The stack or layers of microfoam units 102 are disposed between the advanced composite material layer 104 and the back wall 142.

In the illustrated embodiment, the stack or layers of microfoam units 102 include a first microfoam unit 102a, a second microfoam unit 102b, and a third microfoam unit 102c. The first microfoam unit 102a is positioned between the advanced composite material layer 104 and the second microfoam unit 102b, the second microfoam unit 102b is positioned between the first microfoam unit 102a and the third microfoam unit 102c, the third microfoam unit 102c is positioned between the second microfoam unit 102b and the back wall 142.

The first, second, and third microfoam units 102a, 102b, 102c may have one or more characteristics that differ from one or more of the other microfoam units 102a, 102b, 102c. For instance, in the illustrated embodiment, the first microfoam unit 102a has a thickness (extending between the advanced composite material layer 104 and the second microfoam unit 102b) that differs from the thicknesses of the second and third microfoam units 102b, 102c. Similarly, the second and third microfoam units 102b, 102c have thicknesses that differ from one another. However, in other embodiments, some or all of the microfoam units 102a, 102b, 102c may have thicknesses that are the same as one another.

In the illustrated embodiment, the first microfoam unit 102a has a first porosity level, the second microfoam unit 102b has a second porosity level, and the third microfoam unit 102c has a third porosity level. In the illustrated embodiment, the first porosity level is lower than the second porosity level and the second porosity level is lower than the third porosity level. In other embodiment, the microfoam units 102a, 102b, 102c may have porosity levels that do not increase from the low to high. For instance, the porosity levels may go from high to medium to low, from low to high to medium, from medium to high to low, or from medium to low to high. In other embodiments, two or more of the microfoam units 102a, 102b, 102c may have the same porosity levels.

The microfoam units 102 may vary from one another in one or more other ways, such as different pore sizes, ligament thickness, densities, and/or materials. Using different physical characteristics for the microfoam units 102 may help trap the projectiles therein and enable the primary hypervelocity impact to occur within the structure of the debris shield 140.

While FIG. 4 illustrates the debris shield 140 with three layers of microfoam units 102, it will be appreciated that a debris shield may include fewer or more than three layers of microfoam units 102. Additionally, while FIG. 4 illustrates the microfoam units 102 being positioned directly adjacent to one another, a debris shield may include one or more intermediate layers therebetween. The intermediate layers may include advance composite material layer(s) and/or layers similar to layer 134.

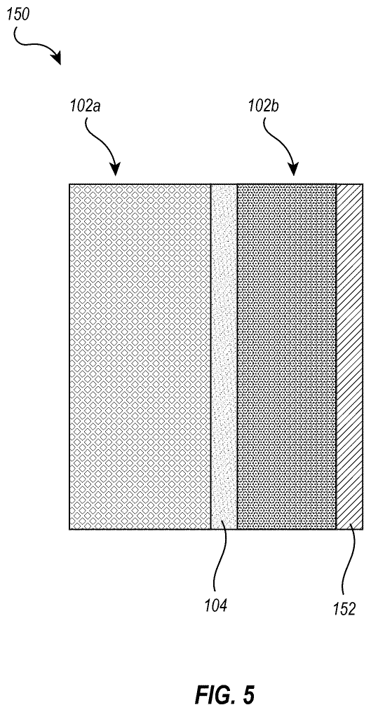

Attention is now directed to FIG. 5, which illustrates a debris shield 150. The illustrated debris shield 150 includes a first microfoam unit 102a, an advanced composite material layer 104, a second microfoam unit 102b, and a back wall 152. In the illustrated embodiment, the advanced composite material layer 104 is disposed between the first and second microfoam units 102a, 102b and the second microfoam unit 102b is disposed between the advanced composite material layer 104 and the back wall 152. The various layers of the debris shield 150 may be similar or identical in various respects to similar components from the other embodiments herein.

Unlike the previous embodiments that used an advance composite material layer 104 as an outer layer of the debris shield, the debris shield 150 uses the microfoam unit 102a as the outer layer. In the illustrated embodiment, the microfoam unit 102a is not filled or impregnated with a PCM, while the microfoam unit 102b is filled or impregnated with PCM. The microfoam units 102a, 102b may have other characteristics (e.g., dimensions, porosity, ligament sizes, materials, etc.) that are the same as or different from one another. In any case, the microfoam unit 102a may be configured to help absorb the kinetic energy and slow down debris that impacts the debris shield. However, the debris may be captured and retained by the microfoam unit 102b.

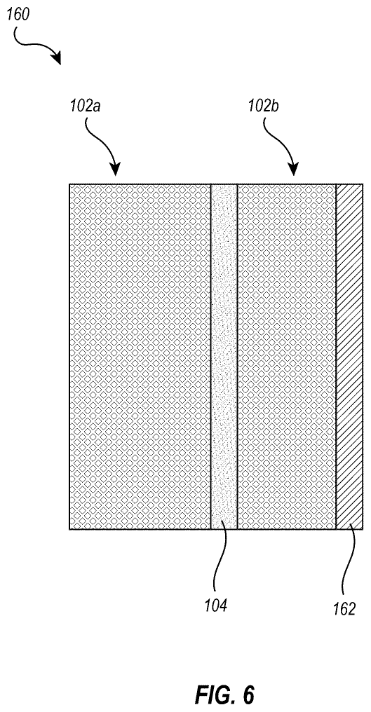

Attention is now directed to FIG. 6, which illustrates a debris shield 160. The illustrated debris shield 160 includes a first microfoam unit 102a, an advanced composite material layer 104, a second microfoam unit 102b, and a back wall 152. The debris shield 160 may be substantially the same as the debris shield 150. However, in the illustrated embodiment, the second microfoam unit 102b is not filled or impregnated with PCM. In other embodiments, the first microfoam unit 102a may be filled or impregnated with PCM.

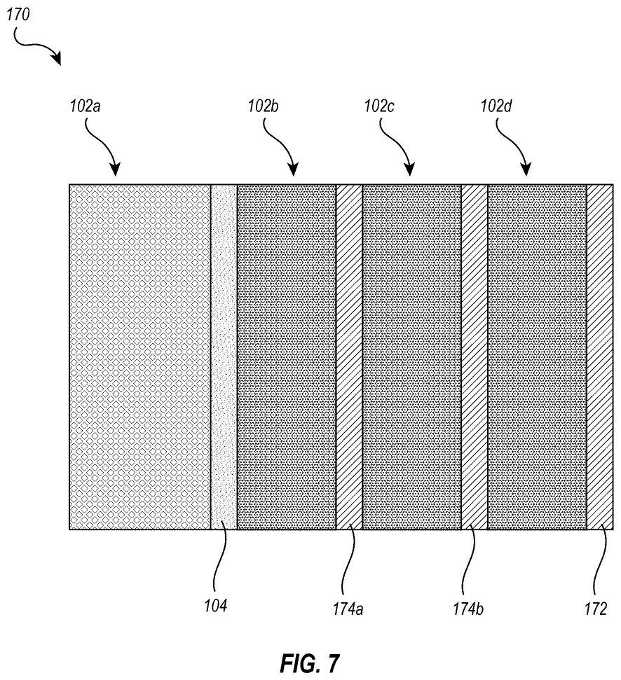

Attention is now directed to FIG. 7, which illustrates a debris shield 170. The illustrated debris shield 170 includes a first, second, third, and fourth microfoam units 102a, 102b, 102c, 102d, an advanced composite material layer 104, a back wall 172, and first and second intermediate layers 174a, 174b. In the illustrated embodiment, the first microfoam unit 102a forms a front of the debris shield 170 and the back wall 172 forms the back of the debris shield 170. The advanced composite material layer 104 is positioned behind the first microfoam unit 102a, followed by the second microfoam unit 102b, the first intermediate layer 174a, the third microfoam unit 102c, the second intermediate layer 174b, and the fourth microfoam unit 102d.

In the illustrated embodiment, the first microfoam unit 102a is not filled or impregnated with PCM while the microfoam units 102b, 102c, 102d are filled with PCM. In other embodiments different combinations of the microfoam units 102a, 102b, 102c, 102d may be filled or not filled with PCM.

The intermediate layers 174a, 174b may be similar or identical to the layer 134 described above. In some embodiments, the intermediate layers 174a, 174b may be similar or identical to the back wall 172.

In light of the various embodiments described above, it will be appreciated that a debris shield may include a variety of layers, including one or more microfoam units, one or more advanced composite material layers, one or more intermediate layers, and/or a back layer. The ordering of the various layers may vary from one embodiment to another and may include any order of one or more of the noted layers. Furthermore, the microfoam units, or subsets thereof, may or may not be filled with PCM.

In at least one embodiment, a space-based vehicle may incorporate this advanced debris shield technology. The debris shield technology may help protect the spaced-based vehicle from debris moving through space. Additionally, because the debris shield technology captures the debris therein, the space-based vehicle can actively clean the orbit by collecting untraceable debris.

In one embodiment, one side of the spaced-based vehicle can be equipped with solar panels to power the space-based vehicle, while the other side may include or be covered with the innovative debris shields described herein to capture debris. By integrating debris collection capabilities with protective shielding, embodiments of the present disclosure represent a significant advancement in space debris mitigation technology, promising enhanced safety for spacecraft and a cleaner orbital environment.

In addition to space-based shield technology, disclosed embodiments not only address the urgent need for effective space debris remediation but also offer potential applications in ballistics and armor design for military and law enforcement.

Embodiment 1. A debris shield comprising: one or more microfoam units, the one or more microfoam units comprising internal voids; one or more phase change materials positioned within the internal voids; and an advanced composite material layer positioned over a surface of the one or more microfoam units.

Embodiment 2. The debris shield of embodiment 1, wherein the one or more phase change materials comprise paraffin wax, salt hydrates, eutectic salts, eutectic metals, microencapsulated PCMs, or composite PCMs.

Embodiment 3. The debris shield of embodiment 1, wherein the one or more microfoam units comprises multiple microfoam units that have different thicknesses, densities, pore sizes, porosities, ligament thicknesses, or materials.

Embodiment 4. The debris shield of embodiment 3, further comprising an advanced composite material layer positioned between two adjacent microfoam units.

Embodiment 5. The debris shield of embodiment 3, the microfoam units have porosity levels that increase from a front side of the debris shield to a back side of the debris shield.

Embodiment 6. The debris shield of embodiment 1, wherein the advanced composite material layer comprises Beta cloth, Nextel or Kevlar.

Embodiment 7. The debris shield of embodiment 1, further comprising an aluminum alloy layer positioned adjacent to the one or more microfoam unit and opposite to the advanced composite material layer.

Embodiment 8. The microfoam shield of embodiment 1, wherein further comprising a back wall formed of an aluminum plate.

Embodiment 9. A debris shield comprising: a first microfoam unit comprising internal voids; a second microfoam unit comprising internal voids; and an advanced composite material layer positioned between the first and second microfoam units.

Embodiment 10. The debris shield of embodiment 9, wherein one or more phase change materials are positioned within the internal voids of the second microfoam unit.

Embodiment 11. The debris shield of embodiment 10, wherein the one or more phase change materials comprise paraffin wax, salt hydrates, eutectic salts, eutectic metals, microencapsulated PCMs, or composite PCMs.

Embodiment 12. The debris shield of embodiment 9, wherein one or more phase change materials are positioned within the internal voids of the first microfoam unit.

Embodiment 13. The debris shield of embodiment 9, further comprising a back wall, the second microfoam unit being positioned between the advanced composite material layers and the back wall.

Embodiment 14. The debris shield of embodiment 13, further comprising one or more additional microfoam units and either one or more additional advanced composite material layers or one or more aluminum intermediate layers positioned between the second microfoam unit and the back wall.

Embodiment 15. The debris shield of embodiment 9, wherein the first and second microfoam units have different thicknesses, densities, pore sizes, porosities, ligament thicknesses, or materials.

Embodiment 16. The debris shield of embodiment 9, wherein the advanced composite material layer comprises Beta cloth, Nextel or Kevlar.

Embodiment 17. A microfoam shield comprising: an advanced composite material layer; a first microfoam unit positioned adjacent to the advanced composite material layer, the first microfoam unit comprising internal voids and a first porosity level; and a second microfoam unit positioned adjacent to the first microfoam unit, such that the first microfoam unit is positioned between the advanced composite material layer and the second microfoam unit, the second microfoam unit comprising internal voids and a second porosity level.

Embodiment 18. The microfoam shield of embodiment 17, wherein the voids of at least one of the first and second microfoam units are filled with one or more phase change materials.

Embodiment 19. The microfoam shield of embodiment 18, wherein the one or more phase change materials comprise paraffin wax, salt hydrates, eutectic salts, eutectic metals, microencapsulated PCMs, or composite PCMs.

Embodiment 20. The debris shield of embodiment 17, wherein the first and second microfoam units have different thicknesses, densities, pore sizes, porosities, ligament thicknesses, or materials.

Embodiment 21. A method for capturing space debris, comprising: positioning a microfoam shield in the path of space debris, wherein the microfoam shield comprises: one or more microfoam stacked layers, internal voids within the one or more microfoam stacked layers, one or more phase change materials positioned within the internal voids, and an advanced composite material layer positioned on top of the one or more microfoam stacked layers; allowing the space debris to impact the microfoam shield, causing the one or more phase change materials to transition from a solid to a liquid phase; and allowing the one or more phase change materials to revert to a solid phase, thereby capturing the space debris fragments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A debris shield comprising:
one or more microfoam units, the one or more microfoam units comprising internal voids;
one or more phase change materials positioned within the internal voids; and
an advanced composite material layer positioned over a surface of the one or more microfoam units.

2. The debris shield of claim 1, wherein the one or more phase change materials comprise paraffin wax, salt hydrates, eutectic salts, eutectic metals, microencapsulated PCMs, or composite PCMs.

3. The debris shield of claim 1, wherein the one or more microfoam units comprises multiple microfoam units that have different thicknesses, densities, pore sizes, porosities, ligament thicknesses, or materials.

4. The debris shield of claim 3, further comprising an advanced composite material layer positioned between two adjacent microfoam units.

5. The debris shield of claim 3, the microfoam units have porosity levels that increase from a front side of the debris shield to a back side of the debris shield.

6. The debris shield of claim 1, wherein the advanced composite material layer comprises Beta cloth, Nextel or Kevlar.

7. The debris shield of claim 1, further comprising an aluminum alloy layer positioned adjacent to the one or more microfoam unit and opposite to the advanced composite material layer.

8. The microfoam shield of claim 1, wherein further comprising a back wall formed of an aluminum plate.

9. A debris shield comprising:
a first microfoam unit comprising internal voids;
a second microfoam unit comprising internal voids; and
an advanced composite material layer positioned between the first and second microfoam units.

10. The debris shield of claim 9, wherein one or more phase change materials are positioned within the internal voids of the second microfoam unit.

11. The debris shield of claim 10, wherein the one or more phase change materials comprise paraffin wax, salt hydrates, eutectic salts, eutectic metals, microencapsulated PCMs, or composite PCMs.

12. The debris shield of claim 9, wherein one or more phase change materials are positioned within the internal voids of the first microfoam unit.

13. The debris shield of claim 9, further comprising a back wall, the second microfoam unit being positioned between the advanced composite material layers and the back wall.

14. The debris shield of claim 13, further comprising one or more additional microfoam units and either one or more additional advanced composite material layers or one or more aluminum intermediate layers positioned between the second microfoam unit and the back wall.

15. The debris shield of claim 9, wherein the first and second microfoam units have different thicknesses, densities, pore sizes, porosities, ligament thicknesses, or materials.

16. The debris shield of claim 9, wherein the advanced composite material layer comprises Beta cloth, Nextel or Kevlar.

17. A microfoam shield comprising:
an advanced composite material layer;
a first microfoam unit positioned adjacent to the advanced composite material layer, the first microfoam unit comprising internal voids and a first porosity level; and
a second microfoam unit positioned adjacent to the first microfoam unit, such that the first microfoam unit is positioned between the advanced composite material layer and the second microfoam unit, the second microfoam unit comprising internal voids and a second porosity level.

18. The microfoam shield of claim 17, wherein the voids of at least one of the first and second microfoam units are filled with one or more phase change materials.

19. The microfoam shield of claim 18, wherein the one or more phase change materials comprise paraffin wax, salt hydrates, eutectic salts, eutectic metals, microencapsulated PCMs, or composite PCMs.

20. The debris shield of claim 17, wherein the first and second microfoam units have different thicknesses, densities, pore sizes, porosities, ligament thicknesses, or materials.
